(19) United States
(12) Patent Application Publication
(10) Pub. No.: US 2014/0070933 A1
(43) Pub. Date: Mar. 13, 2014

(54) VEHICLE USER CONTROL SYSTEM AND METHOD OF PERFORMING A VEHICLE COMMAND

(71) Applicants: Neeraj Roy Gautama, Whitby (CA); Jarvis Chau, Toronto (CA); Norman J. Weigert, Whitby (CA); Amanda J. Kalhous, Ajax (CA)

(72) Inventors: Neeraj Roy Gautama, Whitby (CA); Jarvis Chau, Toronto (CA); Norman J. Weigert, Whitby (CA); Amanda J. Kalhous, Ajax (CA)

(73) Assignee: GM GLOBAL TECHNOLOGY OPERATIONS LLC, Detroit, MI (US)

(21) Appl. No.: 13/606,469

(22) Filed: Sep. 7, 2012

(51) Int. Cl. G08B 6/00

(52) U.S. Cl. 340/438

(57) ABSTRACT

A vehicle user control system includes an interactive pad providing tactile feedback to a user and disposed on an exterior portion of a steering wheel. Also included is a controller in operable communication with the interactive pad and at least one vehicle component, wherein the controller is configured to perform at least one vehicle command associated with the at least one vehicle component.

### FIELD OF THE INVENTION

The subject invention relates to vehicles, and more particularly to a vehicle user control system for use therewith, as well as a method of performing a vehicle command.

### BACKGROUND

Vehicles typically include numerous systems and components that a user is called upon to operate and interact with while operating the vehicle. Each system and/or component often is operated via a switch or some other type of manually manipulated actuator.

The demands of operating the vehicle, including the need to remain alert to, and aware of traffic and road conditions, make it undesirable for users to avert their eyes from the road and/or to remove their hands from the steering wheel. However, when users wish to operate or actuate one or more systems and/or components while operating a vehicle, they may need to momentarily take their eyes off of the road and their hands off of the steering wheel.

Prior efforts to address the above-noted concerns have been directed at mounting redundant controllers/actuators for the various electronic systems and components to a center hub region, as well as a radially outer rim portion, of the steering wheel. Unfortunately, although adequate, the user may inadvertently press the switch and some level of concentration remains necessary to locate the switch.

### SUMMARY OF THE INVENTION

In one exemplary embodiment of the invention, a vehicle user control system includes an interactive pad providing tactile feedback to a user and is disposed on an exterior portion of a steering wheel. Also included is a controller in operable communication with the interactive pad and at least one vehicle component, wherein the controller is configured to perform at least one vehicle command associated with the at least one vehicle component.

In another exemplary embodiment of the invention, a vehicle includes a steering wheel disposed at an interior region of the vehicle. Also included is an interactive pad having a first side and a second side, wherein the interactive pad provides tactile feedback to a user and is disposed on an exterior portion of the steering wheel. Further included is a controller in operable contact with the second side of the interactive pad, wherein the controller is configured to perform at least one vehicle command associated with at least one vehicle component.

In yet another exemplary embodiment of the invention, a method of performing a vehicle command is provided. The method includes contacting a first side of an interactive pad disposed on a steering wheel. Also included is interacting with a controller in communication with a second side of the interactive pad. Further included is providing tactile feedback to a user in contact with the first side of the interactive pad. Yet further included is performing at least one command on at least one vehicle component in response to the interaction with the controller.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic view of a vehicle steering wheel having a vehicle user control system;

FIG. 2 is a perspective view of a portion of the vehicle steering wheel having the vehicle user control system;

FIG. 3 is a schematic view of the vehicle user control system of FIGS. 1 and 2 according to one embodiment;

FIG. 4 is a schematic view of the vehicle user control system according to another embodiment; and

FIG. 5 is a flow diagram illustrating a method of performing a vehicle command with the user control system.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

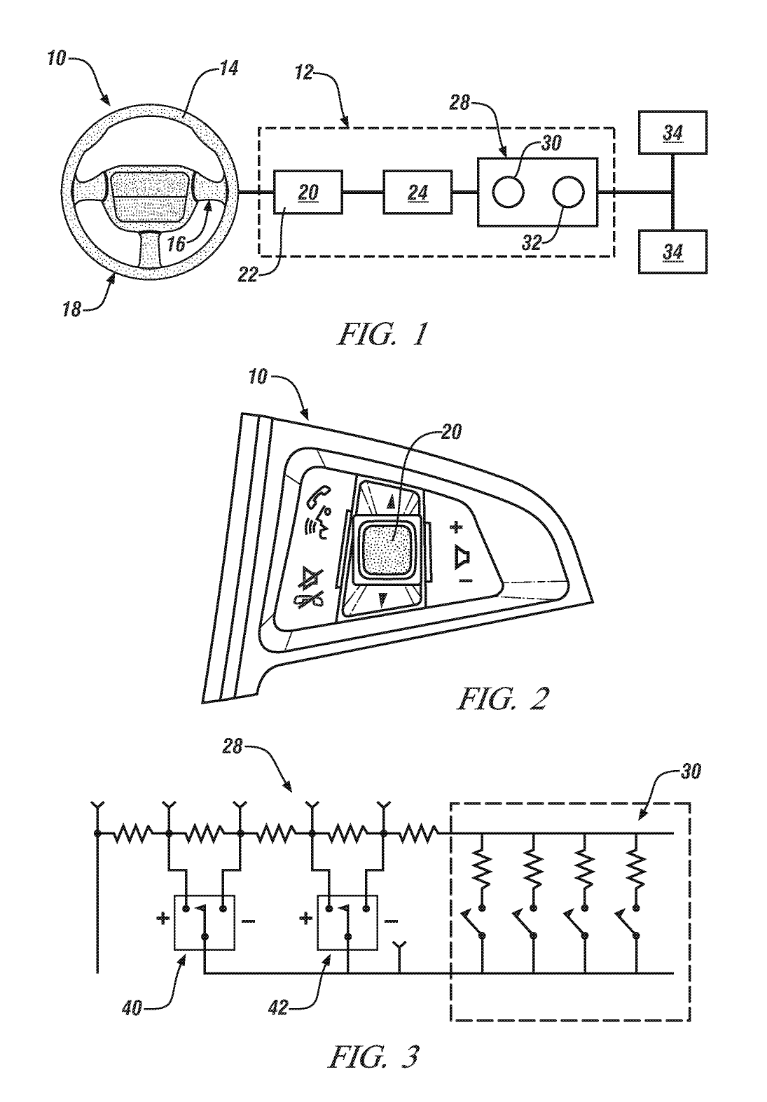

Referring to FIGS. 1-3, in accordance with an exemplary embodiment of the invention, a steering wheel for a vehicle is illustrated and generally referred to with reference numeral 10. The steering wheel 10 includes a vehicle user control system 12 and may be employed in a variety of vehicles, including, but not limited to, an automobile, a boat, ship or aircraft. Additionally, the vehicle user control system 12 may be used with any vehicle system that requires commands from a user during operation of the vehicle.

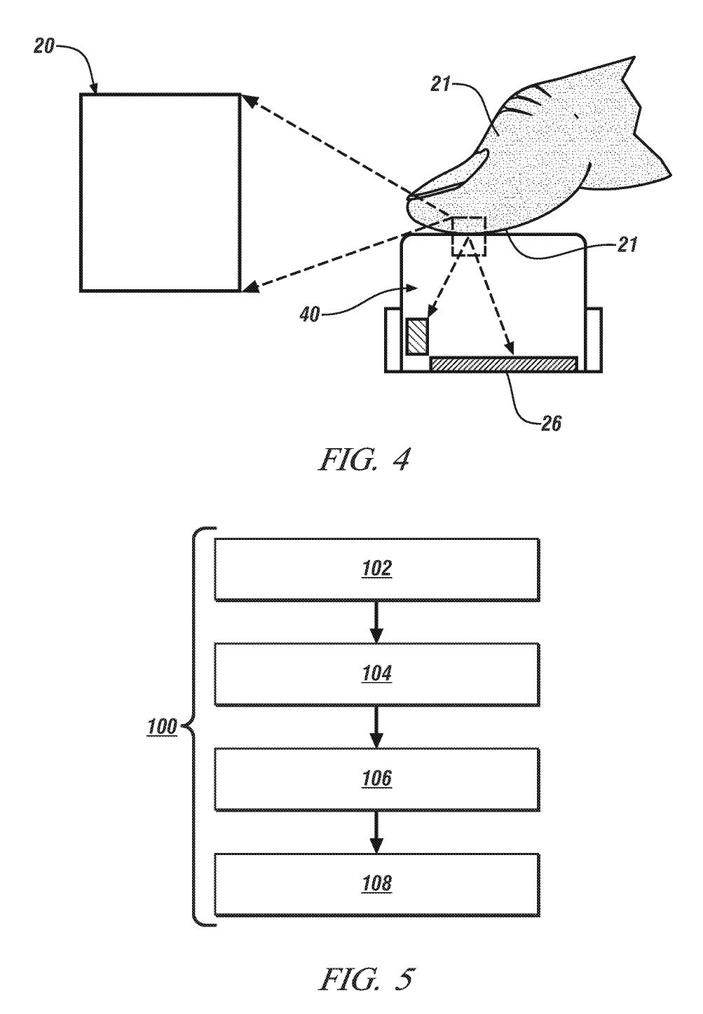

The vehicle user control system 12 is disposed anywhere along an exterior surface 14 of the steering wheel 10, including but not limited to a central hub portion 16 or a radially outer rim portion 18. The vehicle user control system 12 comprises an interactive pad 20 that forms a touch sensitive actuator configured to detect a user's touch and thereby receive at least one, but typically a plurality of gestures made by the user. As used herein, the term “gesture” refers to the deliberate movement of a user's digit(s) 21 (FIG. 4) along a first side 22 of the interactive pad 20. The interactive pad 20 may be in the form of a touch screen that includes a display or simply a track pad. Irrespective of the precise composition of the interactive pad 20, the interactive pad 20 is configured to generate electronic signals that correspond with different gestures made by the user. For example, fingers swept across the surface of the interactive pad 20 in an arc would cause the interactive pad 20 to generate a specific electronic signal. It is to be appreciated that any number of gestures may be received by the interactive pad 20 to generate any number of electronic signals that correspond to a command associated with various vehicle components, as will be described in detail below.

The vehicle user control system 12 is configured to provide tactile feedback to the user during and/or subsequent to completion of the gesture. The tactile feedback provided to the user is generated by a tactile response mechanism 24 that is in operable communication with the interactive pad 20, such that the user receives some form of tactile feedback while touching the first side 22 of the interactive pad 20. The tactile feedback provides confirmation to the user that a certain gesture, and hence a command, is being received by the vehicle user control system 12. Alternatively, or in combination with, as noted above, the tactile feedback may be provided at completion of the gesture and command to provide confirmation that the command has been received. The tactile feedback may be in the form of vibrational pulses that are generated at various frequencies or may be provided as a constant pressure on the first side 22 that may be applied at various intensities. Such a function may be advantageous in numerous respects and applications, with one example being during scrolling through radio stations or channels of an audio system within the vehicle. The feedback may correspond to the rate of scrolling through the stations or channels, such that an increase in the rate of scrolling corresponds to a higher frequency of pulses generated by the tactile response mechanism 24, for example. Additionally, the feedback may correspond to changes in volume. An application corresponding to use with an audio system is shown in FIG. 3, with communication between the interactive pad 20 and a volume control module 40 and a station/channel control module 42.

At this point, it is to be understood that the form of tactile feedback provided by the tactile response mechanism 24 may be applied in numerous manners and may correspond to commands associated with any number of systems within the vehicle, such as an audio system, a video system, a navigation system, a hands-free cellular communication system, a heating, ventilation and air conditioning system (HVAC), a windshield wiper system, a lighting system, a turn signal system, power actuated seat and/or mirror systems, and a cruise control system, for example. It is to be appreciated that the preceding examples of systems that may be commanded by the vehicle user control system 12 are merely illustrative and are not an exhaustive list of systems associated with the vehicle that may be used in conjunction with the vehicle user control system 12.

The interactive pad 20 includes a second side 26 that is oppositely arranged from that of the first side 22, with the second side 26 being in operable communication with a controller 28. The controller 28 comprises a plurality of electrical components, and in an exemplary embodiment includes at least one, but typically a plurality of resistors 30 and a processor 32. The plurality of resistors 30 may be in direct contact with the second side 26 of the interactive pad 20, such that various gestures initiated by the user interact with the plurality of resistors 30 to impart an effect on the controller 28 that produces a variety of electrical signals, which in turn correspond to a command for at least one system or component associated with the vehicle.

In another embodiment (FIG. 4), an optics arrangement 40 comprising a plurality of optics components is disposed in communication with the second side 26 of the interactive pad 20 to receive input from the user. The optics arrangement 40 is also in operable communication with the controller 28 to produce various electrical signals, which facilitates commanding at least one system or component associated with the vehicle. It is contemplated that various alternative arrangements may be employed to receive and relay user input to the controller for enacting commands to the at least one vehicle system or component.

As described above, a wide variety of gestures may be received by the interactive pad 20, and more generally the vehicle user control system 12. Specifically, in addition to the example provided above with respect to an audio system, various gestures may be employed to command an increase or decrease of the interior cabin temperature of the vehicle when associated with an HVAC system, for example. Such a gesture may include swiping of a finger in an upward direction to increase the temperature, while a swiping motion in a downward direction may command a decrease in the temperature. These are merely illustrative and it is to be appreciated that linear swiping motions, arcuate swiping motions, tapping, etc., may all be gestures that provide a command to one or more systems or components associated with the vehicle. The gestures may be default factory settings and/or customizable for user programming, such that the user may determine which gestures correspond to various commands.

It is to be appreciated that embodiments of the vehicle user control system 12, and more specifically the interactive pad 20 is either capacitive or non-capacitive. The non-capacitive embodiment is such that the first side 22 of the interactive pad 20 may be contacted by the user's digit(s) while covered with a material, such as a glove worn in cold weather, for example. A non-capacitive embodiment allows the user to input gestures to the vehicle user control system 12 and effectively carry out the command to at least one system or component associated with the vehicle.

The processor 32 may be any type of computer, computer system, microprocessor, collection of logic devices, a state machine, or any other analog or digital circuitry that is configured to calculate and/or to perform algorithms, and/or to execute software applications, and/or to execute sub-routines, and/or to be loaded with and to execute any type of computer program. The processor 32 may comprise a single processor or a plurality of processors acting in concert. In some embodiments, the processor 32 may be dedicated for use exclusively with the vehicle user control system 12, while in other embodiments the processor 32 may be shared with other systems onboard the vehicle. In still other embodiments, the processor 32 may not be a separate component, but rather, may be integrated into any of the other components of the vehicle user control system 12. Irrespective of the precise configuration and location, the processor 32 is in operable communication with the interactive pad 20, the controller 28, and therefore the plurality of resistors 30. The operable communication may refer to any suitable mode of transmission, including both wired and wireless connections. For example, each component may be physically connected to the processor 32 via a coaxial cable or via any other type of wire connection effective to convey electronic signals. In other embodiments, each component may be coupled to the processor 32 across a bus or other similar communication corridor. Examples of suitable wireless connections include, but are not limited to, a wireless communication protocol identified by the Bluetooth trademark, a Wi-Fi connection, an infrared connection or the like.

In the illustrated embodiment, the controller 28, and therefore the processor 32, is in communication with at least one system 34, which may comprise numerous vehicle components or systems, as described in detail above. Distinct gestures correspond to distinct commands that perform at least one action on the at least one system 34. It is further contemplated that a subsystem selector switch is employed to diminish the need for the user to memorize an excessive number of discrete gestures and instead allows the user to use the same gestures to actuate different vehicle systems or components. Numerous embodiments of the subsystem selector switch are contemplated, with exemplary embodiments including a simple switch, dial, knob, button, or any other suitable mechanical actuator. In other embodiments, the subsystem selector switch may comprise a touch screen display that can provide text or graphical readout for the user that indicates which subsystem is to be controlled in a current operating mode.

A method of performing a vehicle command 100 is also provided as illustrated in FIG. 5 and with reference to FIGS. 1-4. The vehicle user control system 12 has been previously described and specific structural components need not be described in further detail. The method of performing a vehicle command 100 includes contacting a first side of an interactive pad 102 that is disposed on a steering wheel. A user then interacts with a controller 104 having a plurality of resistors that are in communication with a second side of the interactive pad. The vehicle user control system provides tactile feedback to the user 106 that is in contact with the first side of the interactive pad. Based on various gestures performed by the user, the vehicle user control system performs at least one command on at least one vehicle component 108 in response. It is contemplated that the above-described method may be carried out in a different order of steps from that which is outlined above.

Advantageously, the vehicle user control system 12 described above enables the user to operate various systems or components of the vehicle by simply making specific gestures on the interactive pad 20 that is conveniently disposed on the steering wheel 10. The steering wheel 10, and more specifically the vehicle user control system 12, functions as a human machine interface that permits the user to operate multiple systems or components using a single actuator. Use of the vehicle user control system 12 allows the user to interact with the variety of systems or components without having to take their hand off of the steering wheel 10. Furthermore, use of the vehicle user control system 12 can be made intuitive by programming the gestures so that they simulate or mimic the types of motions that are typically used to actuate the conventional switches that are associated with the controllable systems or components.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A vehicle user control system comprising:
an interactive pad providing a tactile feedback sensation to a user and disposed on an exterior portion of a steering wheel; and
a controller in operable communication with the interactive pad and at least one vehicle component, wherein the controller is configured to perform at least one vehicle command associated with the at least one vehicle component.

2. The vehicle user control system of claim 1, wherein the tactile feedback sensation comprises a plurality of pulses at a variety of frequencies.

3. The vehicle user control system of claim 1, wherein the tactile feedback sensation comprises a constant pressure at a variety of intensities.

4. The vehicle user control system of claim 1, wherein the controller further comprises a plurality of resistors in direct communication with the interactive pad.

5. The vehicle user control system of claim 1, wherein the at least one vehicle component comprises at least one of an audio system, a navigation system, a HVAC system, a seat positioning system, a lighting system and a window control system.

6. The vehicle user control system of claim 1, wherein the at least one vehicle component comprises a radio system.

7. The vehicle user control system of claim 6, wherein the at least one vehicle command comprises a change in volume.

8. The vehicle user control system of claim 6, wherein the at least one vehicle command comprises a change in station.

9. The vehicle user control system of claim 1, wherein the controller is non-capacitive.

10. The vehicle user control system of claim 1, wherein the interactive pad comprises a touch screen.

11. The vehicle user control system of claim 1, wherein an optics arrangement for sensing an input from the user is in communication with the interactive pad and with the controller.

12. The vehicle user control system of claim 1, wherein the interactive pad is configured to receive an input from the user, wherein the input comprises at least one of a standardized motion and a customized motion preprogrammed by the user.

13. A vehicle comprising:
a steering wheel disposed at an interior region of the vehicle;
an interactive pad having a first side and a second side, wherein the interactive pad provides tactile feedback to a user and is disposed on an exterior portion of the steering wheel; and
a controller in operable contact with the second side of the interactive pad, wherein the controller is configured to perform at least one vehicle command associated with at least one vehicle component.

14. The vehicle of claim 13, wherein the tactile feedback sensation comprises a plurality of pulses at a variety of frequencies.

15. The vehicle of claim 13, wherein the tactile feedback sensation comprises a constant pressure at a variety of intensities.

16. The vehicle of claim 13, wherein the at least one vehicle component comprises at least one of an audio system, a navigation system, a HVAC system, a seat positioning system, a lighting system and a window control system.

17. The vehicle of claim 13, wherein the at least one vehicle component comprises a radio system.

18. The vehicle of claim 17, wherein the at least one vehicle command comprises a change in volume.

19. The vehicle of claim 17, wherein the at least one vehicle command comprises a change in station.

20. A method of performing a vehicle command comprising:
contacting a first side of an interactive pad disposed on a steering wheel;
interacting with a controller in communication with a second side of the interactive pad;
providing tactile feedback to a user in contact with the first side of the interactive pad; and
performing at least one command on at least one vehicle component in response to the interaction with the controller.
